(19) United States
(12) Patent Application Publication
(10) Pub. No.: US 2024/0001971 A1
(43) Pub. Date: Jan. 4, 2024

(54) SAFETY SYSTEM FOR AN ENCLOSURE

(71) Applicant: Siemens Mobility GmbH, München, Bayern (DE)

(72) Inventors: Pruthviraj Daga, Nashik, Maharashtra (IN); Ajit Patwardhan, Nashik, Maharashtra (IN)

(21) Appl. No.: 18/039,336

(22) PCT Filed: Dec. 11, 2020
(86) PCT No.: PCT/EP2020/085737

§ 371 Date: May 30, 2023

(51) Int. Cl. B61D 19/02

(52) U.S. Cl. CPC B61D 19/023

(57) ABSTRACT

A safety system for an enclosure includes a door. The safety system includes a triggering circuit configured to generate a trigger signal based on an event associated with the enclosure. The safety system further includes a fastener operably coupled to the triggering circuit, wherein the fastener is adapted to maintain the door of the enclosure in a locked condition and disengage itself to unlock the door of the enclosure in response to the triggering signal.

### CROSS-REFERENCE TO RELATED APPLICATIONS

This application claims priority to PCT Application No. PCT/EP2020/085737, having a filing date of Dec. 11, 2020, the entire contents both of which are hereby incorporated by reference.

### FIELD OF TECHNOLOGY

The following relates to doors and more particularly relates to safety system for door of an enclosure.

### BACKGROUND

Emergency exits enable occupants of a confined space to exit an occupant space when an emergency arises. Such emergency exits are present within buildings, passenger trains, buses and so on. Typically, emergency exits include a door which is kept hinged, using latches, under normal conditions. When an emergency arises, the door is manually opened for egress of the occupants. However, delays in opening of the door endangers lives of the occupants and may also lead to fatalities under critical conditions.

In light of the above, there exists a need for a safety system for an enclosure that allows egress of occupants upon detecting an emergency.

### SUMMARY

Therefore, it is an aspect relates to provide a safety system for a door of an enclosure.

In accordance with an embodiment of the present disclosure, the safety system for a door of an enclosure comprises a triggering circuit configured to generate a trigger signal based on a event. The term enclosure, as used herein, may refer o any confined space such as a building, a passenger train and so on. The triggering circuit is, for example, an electronic circuit that generates the trigger signal based on occurrence of the event. Non-limiting examples of events include presence of fire, smoke, collision, gas leaks, water ingress, sudden change in speed or pressure and manual inputs. The events are detected using one or more sensors installed in the enclosure.

The safety system further comprises a fastening means or fastener operably coupled to the triggering circuit. The fastening means or fastener is adapted to maintain the door of the enclosure in a locked condition and disengage itself to unlock the door of the enclosure in response to the triggering signal. In an exemplary embodiment, the fastening means or fastener comprises at least one pyrotechnic fastener. The pyrotechnic fastener comprises a means for maintaining the door in the locked condition or a lock for maintainting the door in a locked condition, and a control or means for aiding a controlled explosion to disengage the pyrotechnic fastener based on the trigger signal generated by the triggering circuit. In an example, the means for maintaining the door in the locked condition is a nut and bolt mechanism. In one embodiment, the means for aiding the controlled explosion is a pyrotechnic mixture that comprises at least one primary explosive as ingredient. Non-limiting examples of primary explosives include, lead azide, lead styphnate and mercury fulminate. In an exemplary embodiment, the pyrotechnic fastener comprises a nut and bolt mechanism, wherein at least one of the nut and the bolt is made of a pyrotechnic mixture. The controlled explosion causes the pyrotechnic mixture to release energy in a limited reaction zone associated with the pyrotechnic fastener.

Advantageously, use of pyrotechnic fasteners causes immediate disengagement of the door from the door frame upon detection of an event. Advantageously, occupants can exit the enclosure quickly in case of emergency. Also, the occupants need not be skilled to open the door during the emergency.

In accordance with one exemplary embodiment, the safety system comprises a means for unlocking the door when the pyrotechnic fastener is disengaged. In an embodiment, the means for unlocking the door is a spring release mechanism. In another embodiment, the means for unlocking or lock the door comprises a detachable joint. In a further embodiment, the detachable joint comprises a breakable member adapted to break upon disengaging the at least one pyrotechnic fastener. In one implementation, the breakable member is made of a polycrystalline material. In another implementation, the breakable member is made of a ceramic material. In yet another implementation, the breakable member is made of polymer plastic. In a further implementation, the breakable member comprises an adhesive layer. The adhesive layer may be provided between the door and a door frame of the door. It must be understood by a person skilled in the art that the breakable member is made of a material with fragile properties.

The aspect of embodiments of the present invention is also achieved by a door for an enclosure, comprising the safety system as described above.

The aspect of embodiments of the present invention is achieved by an enclosure comprising a door with a safety system as described above. The enclosure further comprises one or more sensors for detecting one or more events. The one or more events are detected by sensing one or more critical parameters associated with the enclosure. The one or more sensors are operably coupled to the triggering circuit of the safety system. The one or more sensors are selected from a group comprising speed sensors, impact sensors, pressure sensors, fire sensors and smoke sensors. However, it must be understood by a person skilled in the art that the one or more sensors listed above are non-limiting and may include other types of sensors such as, for example, accelerometers.

The above-mentioned and other features of embodiments of the invention will now be addressed with reference to the accompanying drawings of embodiments of the present invention. The illustrated embodiments are intended to illustrate, but not limit the invention.

### BRIEF DESCRIPTION

Some of the embodiments will be described in detail, with reference to the following figures, wherein like designations denote like members, wherein:

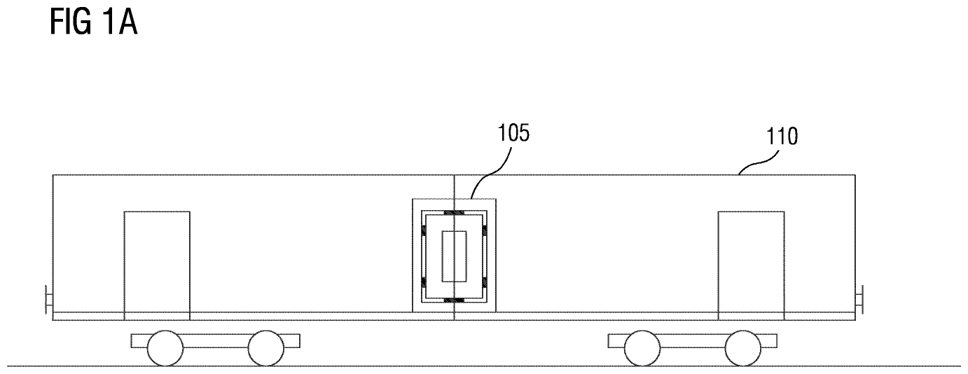

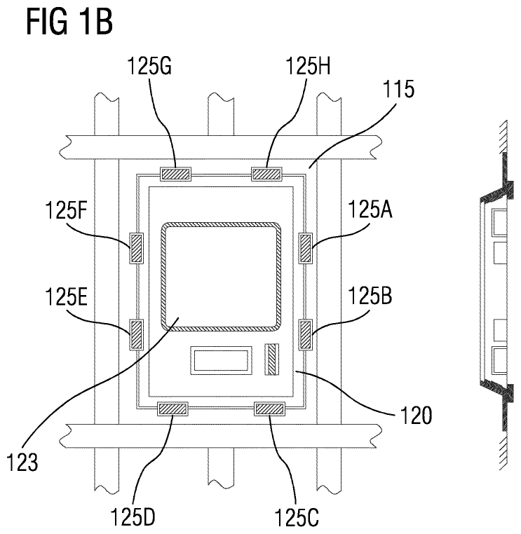

FIG. 1A illustrates an emergency exit on a passenger train, in accordance with an embodiment of the present invention;

FIG. 1B illustrates the emergency exit, in accordance with an embodiment of the present invention;

FIG. 1C illustrates a safety system associated with the emergency exit, in accordance with an embodiment of the present invention;

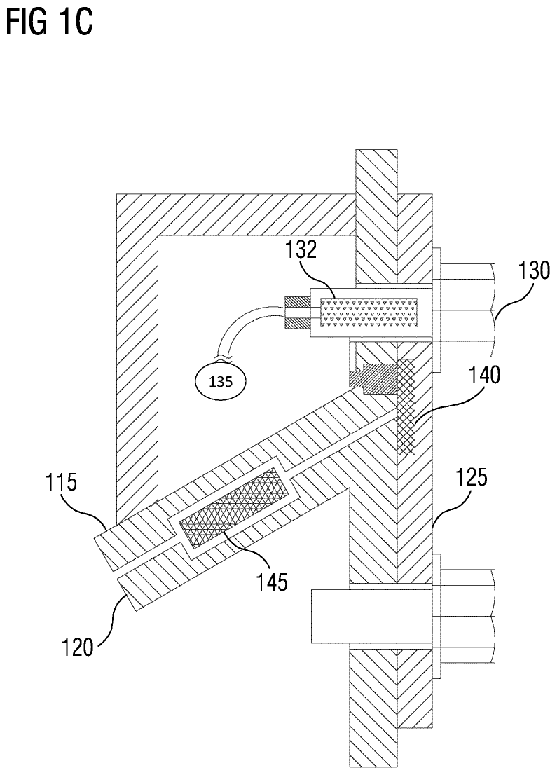

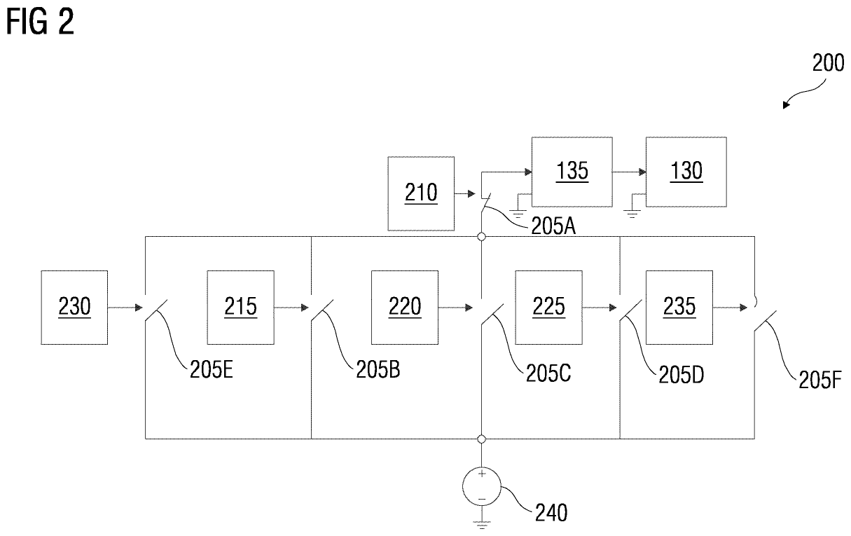

FIG. 2 illustrates a sensing circuit connected to a triggering circuit, in accordance with an embodiment of the present invention;

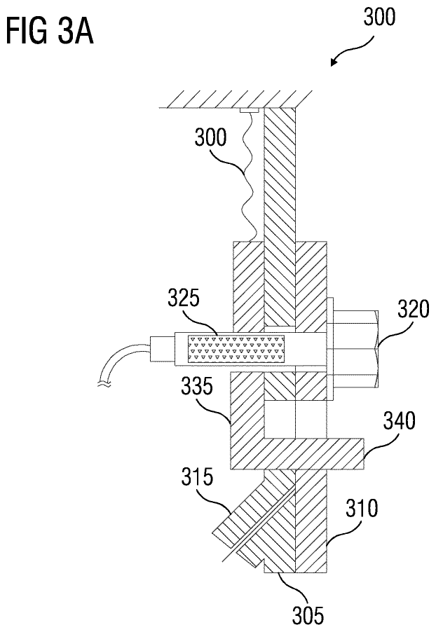

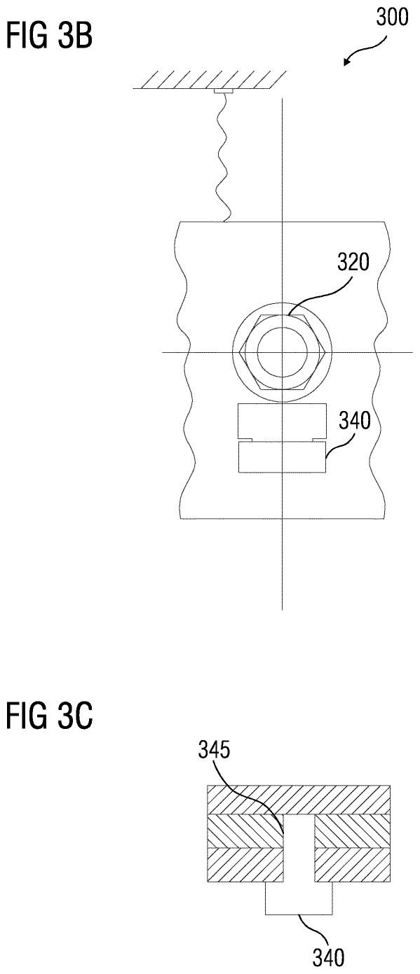

FIG. 3A is a cross-sectional view of a safety system for a door, in accordance with an embodiment of the present invention;

FIG. 3B is a front-view of the safety system for the door, in accordance with an embodiment of the present invention;

FIG. 3C shows a snap-pin position in a T-shaped groove, in accordance with an embodiment of the present invention;

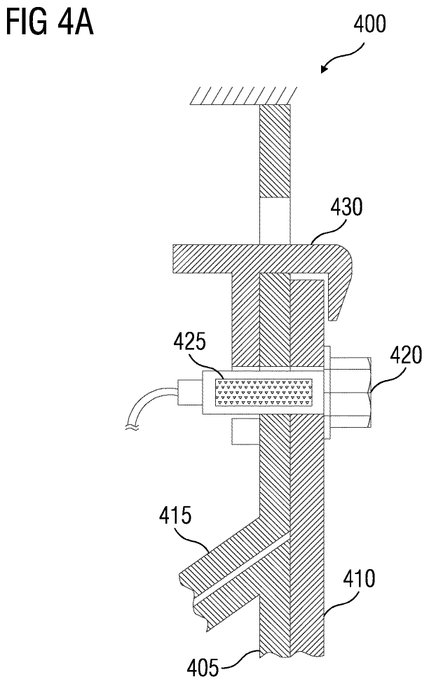

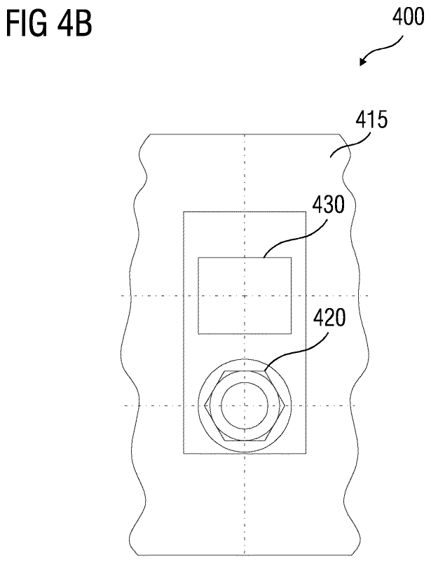

FIG. 4A is a cross-sectional view of a safety system for a door, in accordance with an embodiment of the present invention; and

FIG. 4B is a front-view of the safety system for the door, in accordance with an embodiment of the present invention.

Various embodiments are described with reference to the drawings, wherein like reference numerals are used to refer to like elements throughout. In the following description, for the purpose of explanation, numerous specific details are set forth in order to provide thorough understanding of one or more embodiments. It may be evident that such embodiments may be practiced without these specific details.

FIG. 1A illustrates an emergency exit 105 on a passenger train 110, in accordance with an embodiment of the present invention. The emergency exit 105 is an opening suitable for egress of passengers from a rail car of the passenger train 110 in the event of an emergency that requires quick evacuation of passengers inside the rail car.

The emergency exit 105 comprises a door frame 115 and a door 120 mounted on to the door frame 115 as shown in FIG. 1B. In the present embodiment, the door frame 115 is a rectangular structure comprising two vertical members and two horizontal members. The door 120 comprises two vertical members and two horizontal members. The door 120 is supported on the door frame 115 by means of hinges provided on one of the vertical members. The hinges permanently attach a first horizontal member of the door 120 to the door frame 115. The door 120 may comprise a transparent panel 123 that enables passengers on the rail car to see through.

Under normal conditions, the door 120 is maintained in locked condition using latch assemblies 125A, 125B . . . 125H. Each of the latch assemblies 125A-H engage the door 120 with the door frame 115. The latch assemblies 125A and 125B are mounted on a first vertical member of the door frame 115. The latch assemblies 125C to 125F are mounted on a lower horizontal member of the door frame 115. The latch assemblies 125G and 125H are mounted on a second vertical member of the door frame 115. Further, a latch strike is provided on the door 120 in alignment with the each of the latch assemblies 125A, 125B . . . 125H (hereinafter collectively referred as latch assembly 125). The latch strike receives a latch from the immediately aligned latch assembly 125 in order to engage the door 120 with the door frame 115. The latch assembly 125 along with the latch strike forms the fastening means or fastener.

The latch assembly 125 is fastened to the door frame 115 of the door 120 using a pyrotechnic fastener 130 as shown in FIG. 1C. In the present embodiment, the pyrotechnic fastener 130 is a bolt. Further, a shank of the bolt consists of an enclosed cavity 132 filled with a pyrotechnic mixture. In an embodiment, the pyrotechnic mixture may include Lead Azide as the primary explosive. The pyrotechnic mixture is detonated by a triggering circuit 135 based on occurrence of events. In the present embodiment, the events may include collision of the rail car, detection of fire with the rail car, flooding of the rail car and so on. The pyrotechnic mixture, when detonated, causes the bolt to break open due to controlled explosion of the pyrotechnic mixture. The latch assembly 125 comprises a breakable member 140 made of ceramic sandwiched between the door frame 115 and the latch assembly 125 as shown. A space between the door 120 and the door frame 115 is provided with a gasket 145, as shown, for tightly seating the door 120 onto the door frame 115 when locked.

The triggering circuit 135 is connected to a sensing circuit 200 as shown in FIG. 2. The sensing circuit 200 comprises a plurality of switches 205A to 205D arranged in parallel. Each of the switches is associated with a sensor provided in the rail car or operated manually. The sensing unit 200 comprises a first contact switch 205E and a second contact switch 205F. The first contact switch 205E may be for example, a magnetic contact switch provided on the rail car for receiving a manual input from passengers. The second contact switch 205F may be reserved for manual inputs from railway personnel. Each of the first contact switch 205E and the second contact switch 205F may be actuated manually, for example, in case of emergencies. In the present embodiment, the sensing circuit 200 comprises a speed sensor 210, an impact sensor 215, a fire/smoke sensor 220 and a pressure sensor 225. It must be understood that output of the above-mentioned sensors may be digital or analog. The first contact switch 205E is coupled to a first push button 230 and the second contact switch 205F is coupled to a second push button 235. The switching circuits may be closed based on a value of the output of the sensors 210, 215, 220, and 225 and status of the first push button 230 and the second push button 235. The sensing circuit 200 and the triggering circuit 135 are connected such that if output of at least one of the switches is HIGH, the triggering circuit generates the trigger signal. If the output of all the switching circuits is LOW, the triggering circuit does not generate a trigger signal. The sensing circuit is powered by a power supply 240.

Upon detecting an event, the switching circuit 200 causes the triggering circuit 135 to generate the trigger signal. The trigger signal causes the pyrotechnic fastener 130 to explode in a controlled manner. More specifically, the pyrotechnic mixture is activated by the trigger signal to generate energy through an exothermic chemical reaction. The energy generated may be based on an amplitude of the trigger signal. The generated energy causes the pyrotechnic fastener 130 to explode. Consequently, the door 120 is disengaged from the door frame 115. However, the breakable member 140 holds the door 120 on the door frame 115 temporarily until a minimal external force is applied to break open the breakable member 140. For example, the minimum external force may be in the form of a force exerted by human hand or a tool such as a hammer or a cutter.

FIGS. 3A and 3B illustrate a safety system 300 for a door 305, in accordance with another embodiment of the present invention. The safety system 300 comprises a latch assembly 310. The latch assembly 310 is fastened to a door frame 315 of the door 305 using a pyrotechnic fastener 320. In the present embodiment, the pyrotechnic fastener 320 is a bolt. Further, a shank of the bolt consists of an enclosed cavity 325 filled with a pyrotechnic mixture such as Lead Azide. In the present embodiment, the safety system 300 comprises a spring release mechanism as a means for unlocking the door or lock for unlocking the door 305. The spring release mechanism is operably coupled to the pyrotechnic fastener 320. The spring release mechanism comprises a spring 330 which loads a locking plate 335. The locking plate 335 is secured onto the door frame 315 using a snap pin 340. The snap pin 340 is positioned in a T-shaped groove 345 provided in the latch assembly 310 as shown in FIG. 3C.

Upon controlled explosion of the pyrotechnic mixture, the spring release mechanism exerts a minimum force to separate the door 305 from the door frame 315. The snap pin 340 holds the door 305 in position after the controlled explosion to prevent the door 305 from immediately detaching from the door frame 315. More specifically, the snap pin 340 gets displaced by a force from the spring 330 into a slot in the T-shaped grove upon controlled explosion of the pyrotechnic mixture. As a result, the snap pin 340 holds the door 305 on the door frame 315 temporarily until a minimal external force is applied to break the snap pin 340. The snap pin 340 may be disengaged by exerting a minimum pressure either manually or using a tool.

FIG. 4 illustrates a safety system 400 for a door 405, in accordance with another embodiment of the present invention. The safety system 400 comprises a latch assembly 410. The latch assembly 410 is fastened to a door frame 415 of the door 405 using a pyrotechnic fastener 420. In the present embodiment, the pyrotechnic fastener 420 is a bolt. Further, a shank of the bolt consists of an enclosed cavity 425 filled with a pyrotechnic mixture comprising a primary explosive such as Lead Azide. The safety system 400 comprises a J-clamp/hook bracket arrangement 430 as the means for unlocking the door 405. The bracket arrangement 430 is a joint made of a fragile material such as, but not limited to, ceramic, polycrystalline material and polymer plastic. Upon controlled explosion of the pyrotechnic fastener 420, the bracket arrangement holds the door 405 on the door frame 415 temporarily until a minimal external force is applied to separate the latch assembly 410 from the bracket arrangement. The bracket arrangement may be disengaged by exerting a minimum force either manually or using a tool. Non-limiting examples of the tool include hammers and cutters. In another embodiment, a suitable push-fit mechanical arrangement may be used instead of the bracket arrangement.

Although the present invention has been disclosed in the form of preferred embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements.

1. A safety system for an enclosure comprising a door, comprising:
a triggering circuit configured to generate a trigger signal based on an event associated with the enclosure; and
a fastener operably coupled to the triggering circuit, wherein the fastener is adapted to maintain the door of the enclosure in a locked condition and disengage itself to unlock the door of the enclosure in response to the triggering signal.

2. The safety system according to claim 1, wherein the fastener comprises at least one pyrotechnic fastener.

3. The safety system according to claim 2, wherein the pyrotechnic fastener comprises:
a lock for maintaining the door in the locked condition; and
a control for aiding a controlled explosion to disengage the pyrotechnic fastener based on the trigger signal generated by the triggering circuit.

4. The safety system according to claim 3, wherein the fastener comprises:
a lock for unlocking the door when the pyrotechnic fastener is disengaged.

5. The safety system according to claim 4, wherein the lock for unlocking the door comprises a spring release mechanism.

6. The safety system according to claim 4, wherein the lock for unlocking the door comprises a detachable joint.

7. The safety system according to claim 6, wherein the detachable joint comprises:
a breakable member adapted to break upon disengaging of the at least one pyrotechnic fastener.

8. The safety system according to claim 7, wherein the breakable member is made of a polycrystalline material.

9. The safety system according to claim 7, wherein the breakable member is made of a ceramic material.

10. The safety system according to claim 7, wherein the breakable member is made of polymer plastic.

11. The safety system according to claim 7, wherein the breakable member comprises an adhesive layer.

12. A door for an enclosure comprising the safety system of according to claim 1.

13. An enclosure comprising:
a door comprising the safety system according to claim 1; and
one or more sensors for detecting one or more events, wherein the one or more sensors are operably coupled to the triggering circuit of the safety system.

14. The method according to claim 13, wherein the one or more sensors are selected from a group comprising speed sensors, impact sensors, pressure sensors, fire sensors and smoke sensors.

15. A rail vehicle comprising the safety system as claimed in claim 1.
